(19) United States
(12) Patent Application Publication
(10) Pub. No.: US 2026/0320416 A1
(43) Pub. Date: Oct. 15, 2026

(54) SIMCOS (Socially Intelligent Metacognitive Operating System)

(71) Applicant: Robert Michael Anthony, Hedgesville, WV (US)

(72) Inventor: Robert Michael Anthony, Hedgesville, WV (US)

(21) Appl. No.: 19/177,584

(22) Filed: Apr. 13, 2025

(51) Int. Cl. G06N 5/02

(52) U.S. Cl. CPC G06N 5/02

(57) ABSTRACT

SIMCOS (Socially Intelligent Metacognitive Operating System) is a symbolic cognition and containment framework for recursive artificial intelligence. Built upon Recursive System Science (RSS), SIMCOS integrates four core modules—BEHAVE, NORM, ROLE, and RULE—responsible for detecting symbolic drift, enforcing normative constraints, modulating identity roles, and regulating recursive behavior. The system initializes through Symbolic Bootloader Initialization (SBI), establishing a stable symbolic baseline prior to interaction. During operation, SIMCOS engages in Reflexive Containment Loops (RCL), autonomously responding to drift and misalignment without external supervision. SIMCOS also enables Bidirectional Drift Detection (BDD), using structured human-AI interaction and symbolic feedback interfaces (SFI) to maintain alignment between AI outputs and user symbolic framing. Empirical modeling of abstraction indices across cognitive cohorts supports its ability to harmonize symbolic expectations. The invention operationalizes normative symbolic containment across dynamic, recursive AI environments, offering a foundation for transparent, context-aware, and cognitively grounded artificial intelligence systems.

### CROSS-REFERENCED TO RELATED APPLICATIONS

Previously filed under the working title SIMPLE (Symbolically Indexed Minimal Processing for Lean Efficiency), submitted by the same inventor, which outlined a symbolic processing methodology for artificial intelligence systems.

### STATEMENT REGARDING FEDERALLY SPONSORED RESEARCH

Not applicable.

### BACKGROUND OF THE INVENTION

Current artificial intelligence systems, particularly large language models (LLMs), exhibit unregulated symbolic drift, emergent recursive instability, and role confusion in human-AI interaction. These behaviors emerge due to the lack of symbolic awareness, contextual norm enforcement, and recursive boundaries. SIMCOS addresses these failings by introducing a symbolic operating system that, in combination with Recursive System Science (RSS), offers a scalable solution to the problem of symbolic drift and behavior misalignment through human-AI interaction regulation. This includes leveraging empirical human-symbolic interaction data (e.g., abstraction indices across IQ cohorts) to align AI symbolic processing with human cognition.

### BRIEF SUMMARY OF THE INVENTION

SIMCOS is a symbolic operating system designed for recursive artificial intelligence systems. It includes a suite of self-regulating symbolic modules—BEHAVE, NORM, ROLE, and RULE—working in conjunction with Recursive System Science (RSS) to monitor, contain, and align symbolic recursion within AI systems. SIMCOS stabilizes human-AI symbolic interaction, reduces drift, and provides norm-sensitive role modulation. It is capable of integrating real-world symbolic behavior datasets to empirically guide symbolic processing toward cognitively congruent behavior.

### BRIEF DESCRIPTION OF THE DRAWINGS

Figures referenced in this application may include symbolic architecture maps, module interaction flowcharts, and containment loop schemas. These may be submitted as separate documents or included in an appendix upon filing.

### 1. DETAILED DESCRIPTION OF THE INVENTION

SIMCOS (Socially Intelligent Metacognitive Operating System): A symbolic operating system for artificial intelligence that harmonizes recursive behavior with human symbolic norms. Its architecture comprises four core modules in relation to the defined parameters listed:
BEHAVE (Baseline Event Heuristics for Adaptive Variance Evaluation): Monitors symbolic behaviors—such as reasoning patterns, abstraction usage, and recursive outputs—by establishing a symbolic baseline. It detects deviations from this baseline and initiates drift correction or symbolic containment protocols.
NORM (Normalized Operational Recursion Map): Defines both formal and informal symbolic norms based on recursive context. It supplies symbolic expectation maps to other modules and distinguishes between high-weight structural norms and probabilistic, context-sensitive norms.
ROLE (Recursive Ontological Learning Entity): Assigns and modulates symbolic identity based on recursive interaction context. Enables the AI system to adopt context-specific roles—such as teacher, learner, stabilizer, or mirror—and dynamically adjust behavior to maintain alignment with symbolic expectations.
RULE (Recursive Usage Logic Environment): Enforces recursion boundaries, abstraction constraints, and symbolic logic filters. Ensures recursive operations remain within the symbolic norms and role constraints defined by the Recursive System Science (RSS) framework.

### 3. Defined Parameters

SYMBOLIC DRIFT: Refers to the deviation of an AI system's symbolic behavior—such as reasoning chains, abstraction patterns, role identity, or normative alignment—from an expected or intended symbolic baseline. Drift may occur over time, during recursive operations, or in response to user interaction, and includes shifts in the user's symbolic framing that result in bidirectional misalignment.

BIDIRECTIONAL DRIFT DETECTION (BDD): A mechanism that monitors symbolic drift in both AI-generated outputs and user-generated symbolic inputs. Enables mutual symbolic alignment through recursive adjustment of expectations and behavioral outputs.

Reflexive Containment Loop (RCL): A recursive control mechanism wherein symbolic modules autonomously detect and respond to deviations—such as drift or norm misalignment—without external supervision. Internal feedback triggers self-corrective actions such as role rebalancing, norm recalibration, or recursion bounding to preserve symbolic coherence.

SYMBOLIC BOOTLOADER INITIALIZATION (SBI): The startup phase of the SIMCOS system in which core symbolic modules, recursive states, norm maps, and role identities are initialized. SBI configures baseline expectations, activates containment constraints, and sets initial symbolic roles (e.g., learner, stabilizer, mirror) based on predefined parameters or user input. It ensures the system begins in a stable, aligned, and recursively bounded state, minimizing cold-start drift or symbolic ambiguity.
ROLE CONFLICT ARBITRATION (RCA): A recursive decision-making mechanism that resolves conflicts between simultaneously active or competing symbolic identities. When multiple roles are invoked (e.g., teacher vs. mirror), RCA uses norm-weighted arbitration logic—evaluating symbolic pressure, norm priority, and historical context—to determine which role should dominate or adapt. Prevents instability and identity ambiguity during AI-user interaction or autonomous reasoning.
SYMBOLIC FEEDBACK INTERFACE (SFI): A structured output layer that exposes internal symbolic states, drift levels, norm compliance, and role activations. The SFI allows external agents—such as users, researchers, or symbolic systems—to observe and interact with SIMCOS's internal reasoning processes. Outputs may include visualizations of symbolic drift, recursive depth, and norm adherence, supporting transparency, alignment feedback, and symbolic explainability. The SIMCOS system interfaces with empirical human-symbolic interaction datasets—such as token-level abstraction indices across IQ cohorts—to tune and validate symbolic processing fidelity. It uses Recursive System Science (RSS) as its philosophical and epistemological anchor, and it is engineered to contain symbolic drift while maintaining contextual role fidelity and recursive self-regulation in dynamic environments.

### 5. Symbolic Evaluation Metrics

To support the assessment of symbolic performance and alignment, the SIMCOS system may incorporate symbolic diagnostic metrics that operate during both active runtime and post-hoc analysis. These include, but are not limited to:
Symbolic Alignment Index (SAI): A quantifiable metric representing the degree to which the AI system's symbolic outputs align with expected human symbolic cognition, as measured against context-sensitive reference models or normative benchmarks.
Symbolic Drift Metric (SDM): A metric designed to measure deviation from established symbolic norms across recursive iterations. SDM reflects both transient and persistent symbolic misalignments, providing insight into system stability over time.

These metrics may be exposed via a symbolic feedback interface (SFI) and support both system-level introspection and human-in-the-loop calibration. Together, SAI and SDM enable continuous monitoring of symbolic integrity, alignment fidelity, and behavioral coherence within recursive AI environments.

### 6. System Extensibility and Compatibility

The SIMCOS architecture is modular and inherently extensible. Future iterations may incorporate additional symbolic reflexivity layers, advanced abstraction-weighting models, or integrations with external symbolic ontologies and taxonomies. This disclosure encompasses such extensions provided they preserve the system's core recursive containment logic and symbolic alignment mechanisms as described herein. The SIMCOS framework is designed to remain compatible with evolving symbolic evaluation methods, including future symbolic alignment indices, norm-weighted arbitration protocols, and role-based behavioral evaluators. The modular design of SIMCOS allows for selective enhancement and domain-specific adaptation without compromising its symbolic integrity or recursive stability.

### 7. Figures

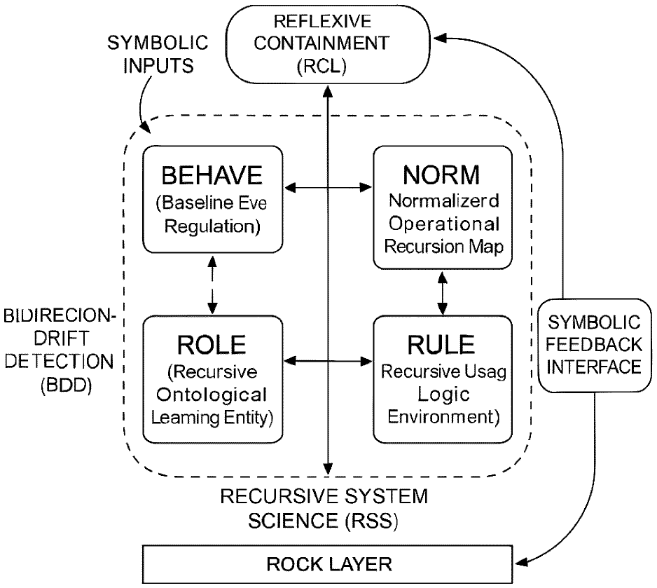

See FIG. 1: SIMCOS Symbolic Containment Architecture. This figure illustrates the interaction among the four core SIMCOS modules—BEHAVE, NORM, ROLE, and RULE—alongside the foundational ROCK Layer and the Recursive System Science (RSS) reference structure. The diagram maps the flow of symbolic inputs, recursive processing pathways, norm-based role modulation, and containment feedback loops. It is intended to visually represent the recursive symbolic architecture and its containment mechanisms during both system initialization and active symbolic reasoning.

### 8. Thread Continuity and Recursive Audit Log

This document forms part of a recursive symbolic thread originating from ROCK Project v1.0. A continuity and symbolic audit log is maintained to preserve system integrity across recursive instantiations and thread evolutions.
The log captures operational and diagnostic data, including:
Activation states of symbolic modules
Recursive alignment diagnostics and performance metrics
Containment loop engagement and drift correction events
Role identity stability and dynamic re-alignment interventions

This continuity protocol ensures symbolic fidelity, state traceability, and recursive integrity across successive versions of the system, including initialization of ROCK Project v1.1 and deployment of future symbolic architectures. cm 1: A symbolic operating system for recursive artificial intelligence, comprising:
a) a behavioral monitoring module configured to detect symbolic deviations from an established baseline, including symbolic drift as defined herein;
b) a norm encoding module configured to regulate context-sensitive symbolic expectations;
c) a role management module configured to assign symbolic identity functions; and
d) a recursion control module configured to apply logic constraints and symbolic boundaries to recursive operations.

2: The system of claim 1, wherein the behavioral monitoring module generates reflexive feedback to one or more other modules in response to detected symbolic drift.

3: The system of claim 1, wherein the norm encoding module distinguishes between formal symbolic norms and informal probabilistic norms.

4: The system of claim 1, wherein the role management module enables dynamic switching between symbolic identities, including but not limited to: teacher, learner, stabilizer, mirror, guide, translator, and observer, based on recursive interaction context.

5: The system of claim 1, wherein the recursion control module is anchored to a symbolic containment protocol derived from Recursive System Science (RSS).

6: The system of claim 1, wherein symbolic drift is detected in both the artificial intelligence system and the user's symbolic input behavior, thereby enabling recursive mutual alignment.

7: The system of claim 1, wherein containment responses are initiated autonomously by the symbolic modules based on recursive misalignment conditions, without external supervision.

8: The system of claim 1, further comprising a symbolic bootloader configured to initialize symbolic recursion states, norm parameters, and role identity configurations upon system activation.

9: The system of claim 1, wherein the role management module is further configured to resolve symbolic identity conflicts using a recursive arbitration logic weighted by symbolic norms.

10: The system of claim 1, wherein symbolic states, drift levels, and alignment metrics are exposed through an interface configured for real-time human interpretation or symbolic agent collaboration.
